(19) United States
(12) Patent Application Publication
(10) Pub. No.: US 2015/0146521 A1
(43) Pub. Date: May 28, 2015

(54) DYNAMIC RESOURCE POOLING AND TRADING MECHANISM IN NETWORK VIRTUALIZATION

(71) Applicant: Futurewei Technologies, Inc., Plano, TX (US)

(72) Inventors: Jiafeng ZHU, San Ramon, CA (US); Weisheng XIE, Dallas, TX (US); Min LUO, San Jose, CA (US); Wu CHOU, Basking Ridge, NJ (US); Arularasi SIVASANKARAN, Santa Clara, CA (US)

(21) Appl. No.: 14/553,839

(22) Filed: Nov. 25, 2014

Related U.S. Application Data
(60) Provisional application No. 61/909,265, filed on Nov. 26, 2013.

(51) Int. Cl. H04L 12/14; H04L 12/911; H04L 12/26; H04L 12/923

(52) U.S. Cl. CPC H04L 12/1432; H04L 47/762; H04L 47/783; H04L 47/826; H04L 43/0882
USPC 370/229

(57) ABSTRACT

A method for managing a pool of bandwidth resources available over a communication network as executed by a processor. The method includes receiving a plurality of wholesale bandwidth values requesting bandwidth from the pool of bandwidth resources from a plurality of computing resources associated with the plurality of customers, wherein the wholesale bandwidth values are guaranteed over a predetermined period, and wherein the pool has a maximum capacity. The method includes tracking bandwidth resource usage throughout the predetermined period. The method includes allocating a first portion of available bandwidth from the pool to a first customer based on a reselling rate ratio applicable to the plurality of customers at a particular point in time during the predetermined period. Available bandwidth is generated by purchasing unused bandwidth from the plurality of customers over the predetermined period.

### CROSS REFERENCE TO RELATED APPLICATIONS

The present application claims priority to and the benefit of the commonly owned, provisional patent application, U.S. Ser. No. 61/909,265, entitled “DYNAMIC RESOURCE POOLING AND TRADING MECHANISM IN NETWORK VIRTUALIZATION,” with filing date Nov. 26, 2013, and having attorney docket number HW-91012294US02, which is herein incorporated by reference in its entirety.

### BACKGROUND

The current ossified internet is facing problems supporting high-bandwidth heterogeneous applications with the emergence of cloud-based services and big data. A more dynamic computing and network infrastructure is required for the future growth of internet. In recent years, network virtualization has attracted the attention from both the academia and industry as a long-term solution to replace the existing internet. In network virtualization, each virtual network (VN) is a partition or aggregation of the underlined physical network (PN) resources, tailored to the specific requirements of the applications. Network virtualization is the key technology to enable multiple isolated VNs to share a common substrate.

In network virtualization, the PN provider (carrier) is responsible for allocating a part of its infrastructure resources to the VNs. The problem of mapping a virtual node to a physical node and mapping a virtual link to a physical path is called VN embedding or VN mapping problem. In the traditional VN embedding problems, the bandwidth is allocated exclusively. The VN provider (user) requests the same bandwidth amount as its peak traffic demand, and it does not share the unused bandwidth with other VNs. If the peak traffic demand only happens occasionally, the bandwidth utilization will be low.

Most of the current research works on network virtualization assume exclusive bandwidth allocation. The user's requested bandwidth is equal to its peak traffic demand. There are a few studies analyzing the overbooking problem in network virtualization. Some users require full availability exclusive service, while the others can accept limited availability service as long as the service level agreement (SLA) is not violated. This can be extended by formulating a mixed integer linear programming (MILP) to minimize the virtual network cost, given the diverse degrees of availability of the users. An analytic model has been formulated to quantify the performance impact of overbooking virtualized resources as a function of the relevant environment and usage parameters.

However, these approaches on overbooking just analyze the performance impact of overbooking and how many more users may be multiplexed without violating the SLA. Although the users can share the bandwidth to a certain degree, their requested bandwidth is still statically provisioned. They don't have a dynamic bandwidth exchange mechanism to specify how to distribute the unused bandwidth.

### SUMMARY

In some embodiments of the present invention, a computer system for managing a pool of bandwidth resources available over a communication network is disclosed. The computer system includes a processor configured to receive a plurality of wholesale bandwidth values requesting bandwidth from the pool of bandwidth resource from a plurality of computing resources associated with a plurality of customers. The wholesale bandwidth values are guaranteed over the predetermined period, and wherein the pool has a maximum capacity. The processor is configured to track bandwidth resource usage throughout the predetermined period. The processor is configured to allocate a first portion of available bandwidth from the pool to a first customer based on a reselling rate ratio applicable to the plurality of customers at a particular point in time during the predetermined period. Available bandwidth is generated by purchasing unused bandwidth from the plurality of customers over the predetermined period.

In other embodiments of the present invention, a method for managing a pool of bandwidth resources available over a communication network executed by a processor is disclosed. The method includes receiving a plurality of wholesale bandwidth values requesting bandwidth from the pool of bandwidth resources from a plurality of computing resources associated with a plurality of customers. The wholesale bandwidth values are guaranteed over a predetermined period, and wherein the pool has a maximum capacity. The method includes tracking bandwidth resource usage throughout the predetermined period. The method includes allocating a first portion of available bandwidth from the pool to a first customer based on a reselling rate ratio applicable to the plurality of customers at a particular point in time during the predetermined period. Available bandwidth is generated by purchasing unused bandwidth from the plurality of customers over the predetermined period.

In still other embodiments of the present invention, a non-transitory computer-readable medium having computer-executable instructions for causing a computer system to perform a method for managing a pool of bandwidth resources available over a communication network is disclosed. The method includes receiving a plurality of wholesale bandwidth values from a plurality of computing resources associated with a plurality of customers. The wholesale bandwidth values are guaranteed over a predetermined period, and wherein the pool has a maximum capacity. The method includes tracking bandwidth resource usage throughout the predetermined period. The method includes allocating a first portion of available bandwidth from the pool to a first customer based on a reselling rate ratio applicable to the plurality of customers at a particular point in time during the predetermined period. Available bandwidth is generated by purchasing unused bandwidth from the plurality of customers over the predetermined period.

This summary is provided to introduce a selection of concepts in a simplified form that is further described below in the detailed description that follows. This summary is not intended to identify key features or essential features of the claimed subject matter, nor is it intended to be used to limit the scope of the claimed subject matter.

### BRIEF DESCRIPTION

The accompanying drawings, which are incorporated in and form a part of this specification and in which like numerals depict like elements, illustrate embodiments of the present disclosure and, together with the description, serve to explain the principles of the disclosure.

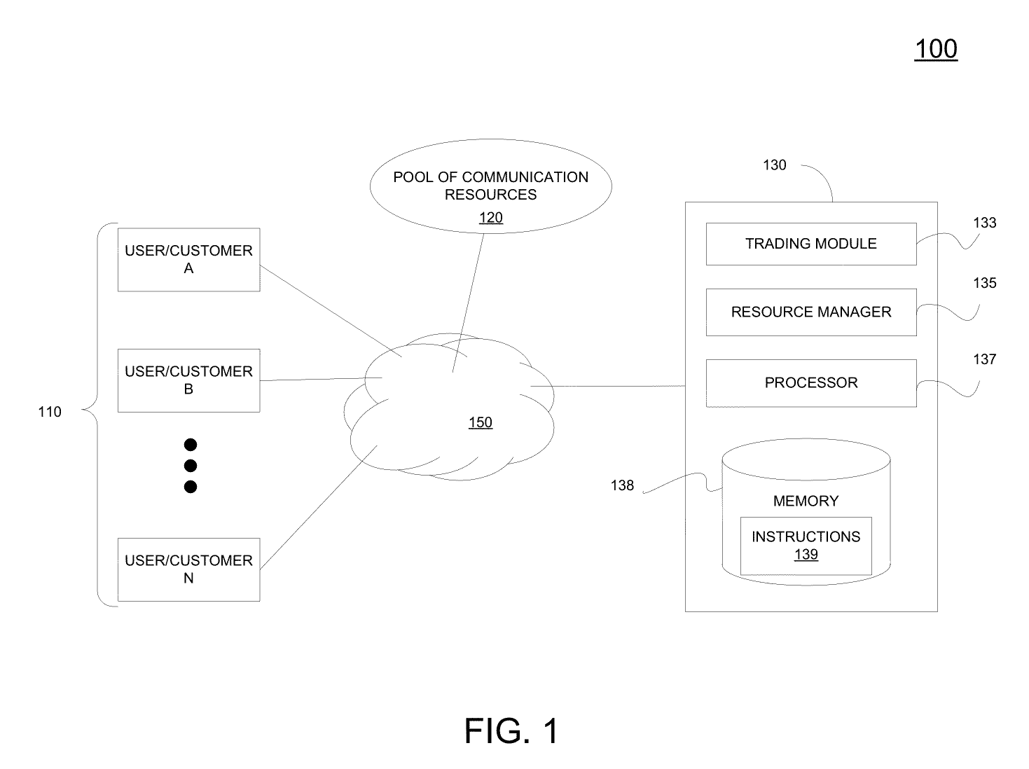

FIG. 1 is an illustration of a trading mechanism configured for dynamic resource pooling in a communications network, in accordance with one embodiment of the present disclosure.

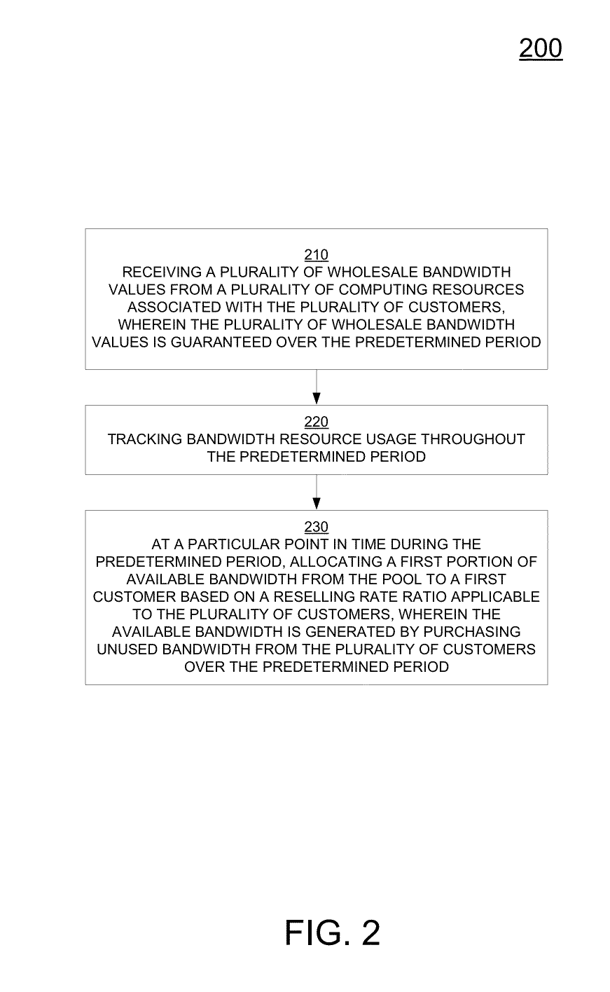

FIG. 2 is a flow diagram illustrating steps in a method for dynamic resource (e.g., bandwidth) provisioning from a resource pool in a communications network, in accordance with one embodiment of the present disclosure.

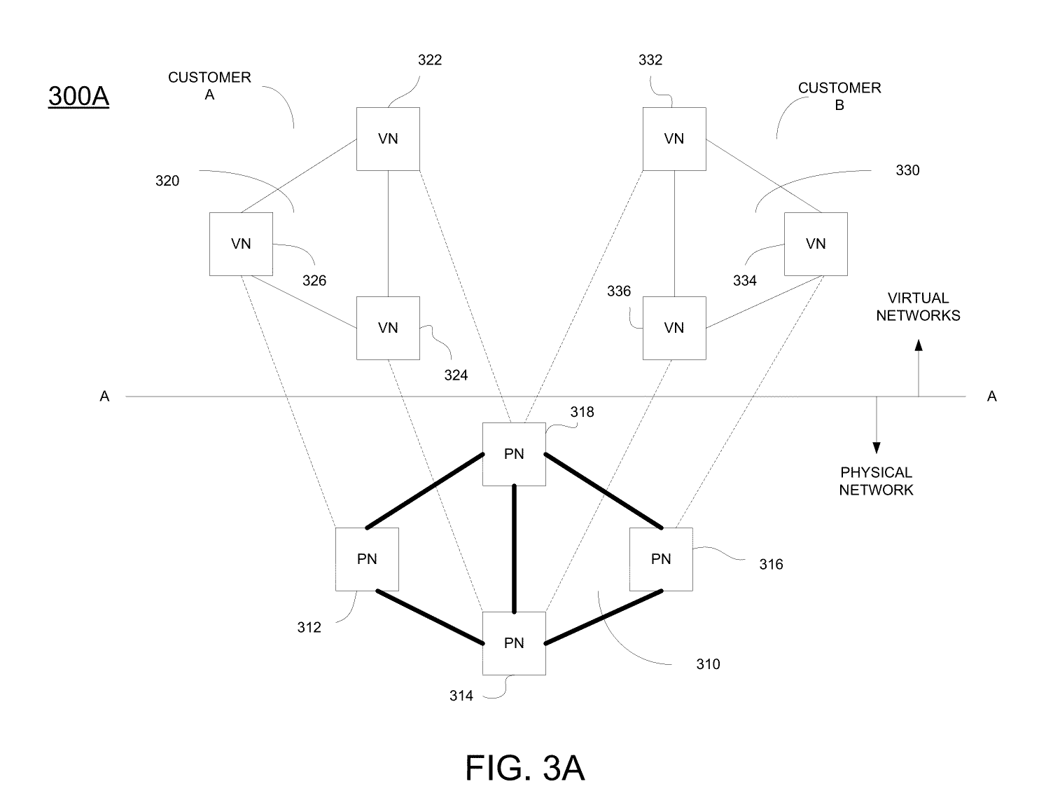

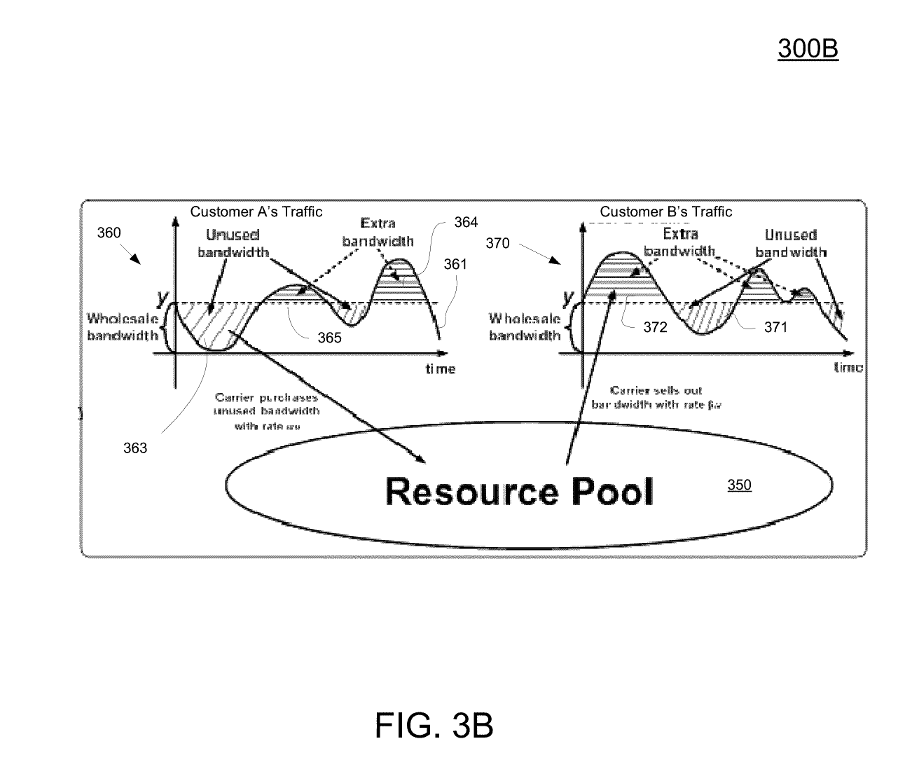

FIG. 3A is an illustration of network virtualization built upon resources of a physical network, in accordance with one embodiment of the present disclosure.

FIG. 3B is a diagram illustrating the use of bandwidth allocated from a resource pool providing communications resources over a period of time, in accordance with one embodiment of the present disclosure.

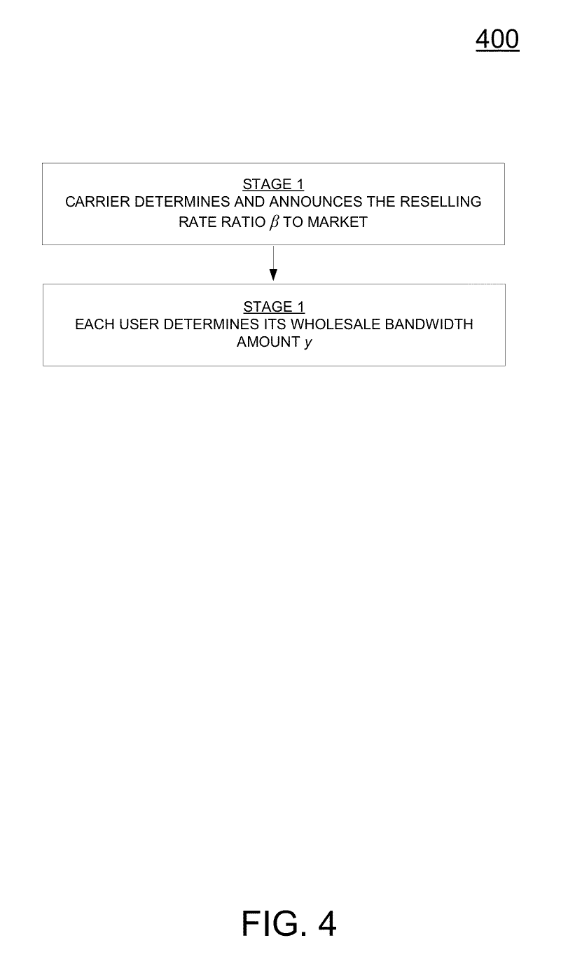

FIG. 4 is a flow diagram illustrating steps in a method for implementing a two-stage Stackelberg game, used to implement dynamic resource pooling in a communications network, in accordance with one embodiment of the present disclosure.

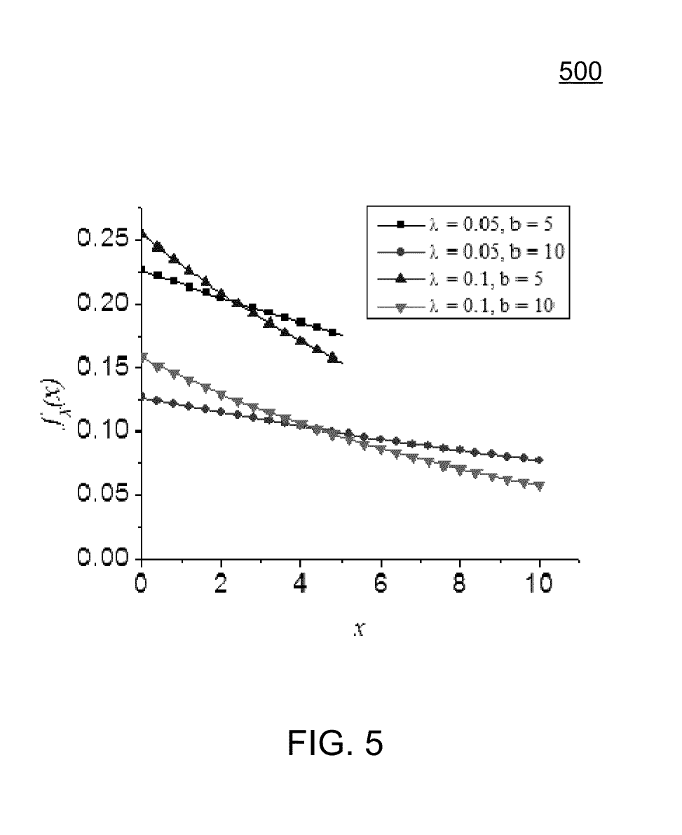

FIG. 5 is a graph illustrating an example of a probability density function of traffic distribution, in accordance with one embodiment of the present disclosure.

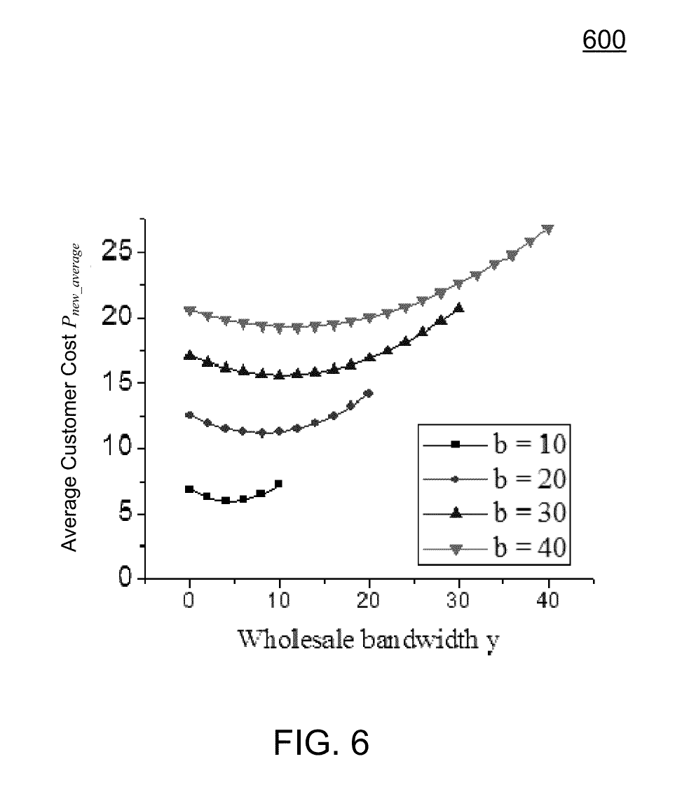

FIG. 6 is a graph illustrating an example of average user cost versus wholesale bandwidth amount, in accordance with one embodiment of the present disclosure.

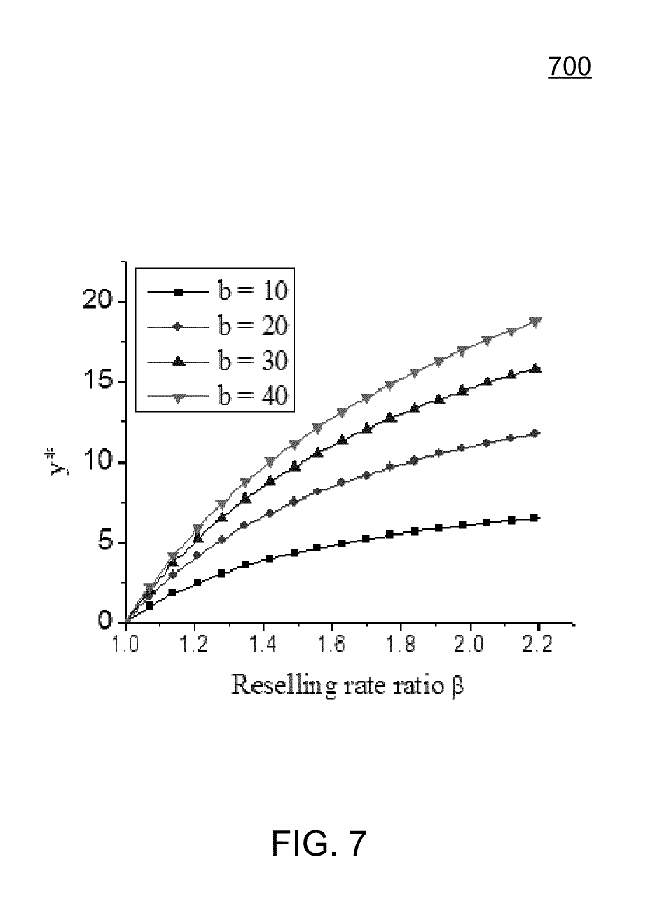

FIG. 7 is a graph illustrating an example of wholesale bandwidth amount that minimizes user cost versus reselling ratio, in accordance with one embodiment of the present disclosure.

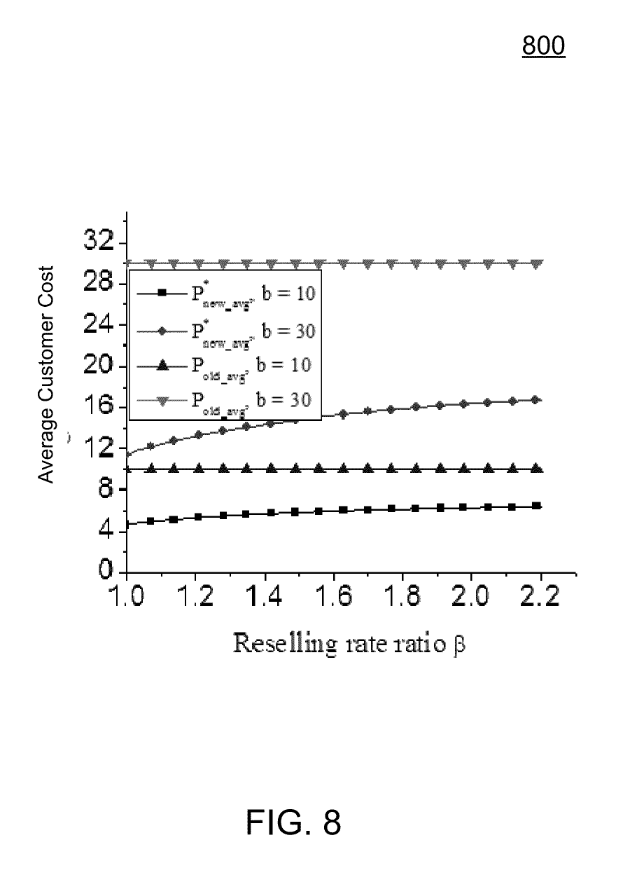

FIG. 8 is a graph illustrating an example of average user cost versus reselling ratio in accordance with one embodiment of the present disclosure.

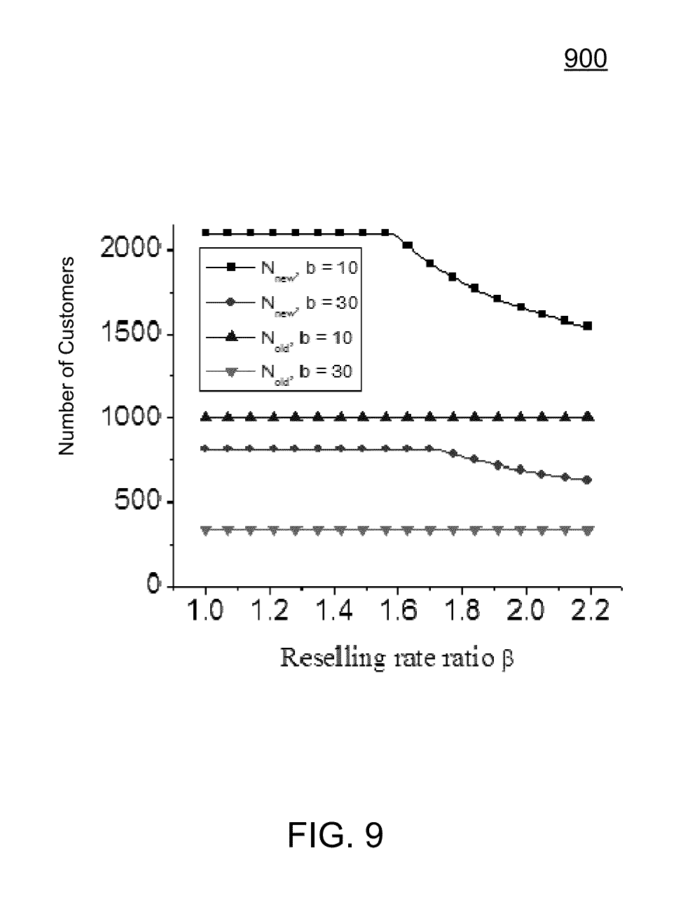

FIG. 9 is a graph illustrating an example of average number of users versus reselling ratio, in accordance with one embodiment of the present disclosure.

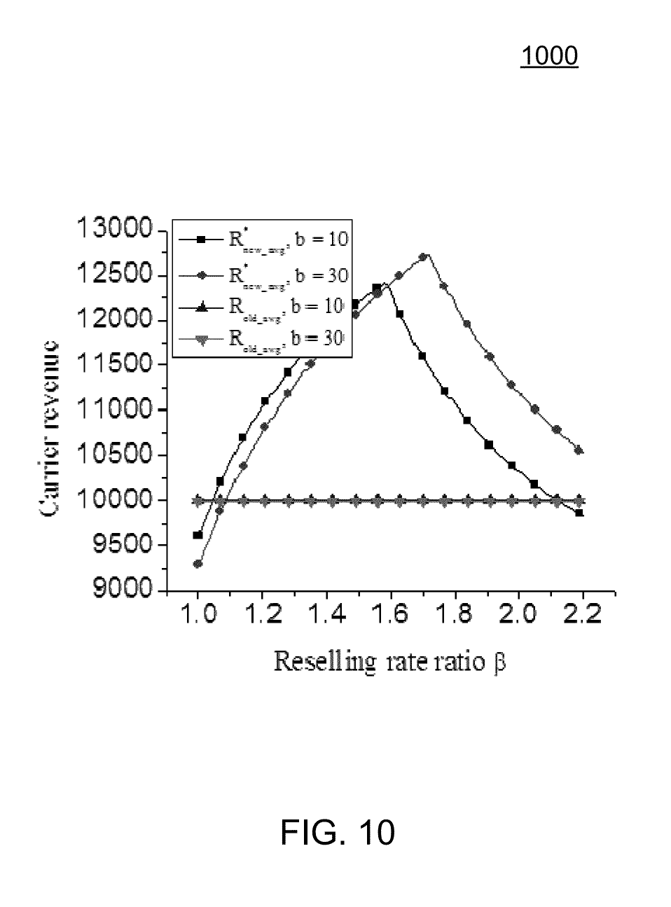

FIG. 10 is a graph illustrating an example of carrier revenue versus reselling ratio, in accordance with one embodiment of the present disclosure.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Accordingly, embodiments of the present invention provide for fast and self-service bandwidth provisioning in a communication network. That is, embodiments according to the present invention analyze the user cost and the carrier revenue to manage usage and allocation of a pool of resources under a scenario of overbooking virtualized resources. For instance, software-defined networking (SDN) protocols can be implemented to provide for automated bandwidth provisioning, wherein SDN decouples the control and data planes to offer a flexible network automation and management framework. As such, based on SDN technology, a dynamic bandwidth trading mechanism implemented through network virtualization is described, which greatly improves bandwidth utilization, reduces overall user cost, and increases carrier revenue. In an example of dynamic resource (e.g., bandwidth) provisioning, a user requests a long-term bandwidth amount from a carrier at the beginning, which is typically lower than the peak traffic demand. As time goes on, the user sells its unused bandwidth back to the carrier at a reduced rate. The carrier creates and manages a resource pool to gather the unused bandwidth. If the user or another user needs extra bandwidth to accommodate its peak traffic demand, the user may search the resource pool for the bandwidth and buys the bandwidth from the carrier at an increased rate. In this way, the user does not need to exclusively reserve bandwidth in accordance with its peak traffic demand. The trading process/mechanism can be formulated as a Stackelberg game. A Subgame Perfect Equilibrium (SPE) can be found having numerical results that show the benefits of the disclosed trading mechanism.

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer generated step, logic block, process, etc., is here, and generally, conceived to be a self-consistent sequence of steps or instructions leading to a desired result. The steps are those requiring physical manipulations of physical quantities, and refer to the action and processes of a computing system, or the like, including a processor configured to manipulate and transform data represented as physical (electronic) quantities within the computer system's registers and memories into other data similarly represented as physical quantities within the computer system memories or registers or other such information storage, transmission or display devices.

Flowcharts of examples of methods for providing dynamic resource pooling and resource management in a communications network are described, according to embodiments of the present invention. Although specific steps are disclosed in the flowcharts, such steps are exemplary. That is, embodiments of the present invention are well-suited to performing various other steps or variations of the steps recited in the flowcharts. Also, embodiments described herein may be discussed in the general context of computer-executable instructions residing on some form of computer-readable storage medium, such as program modules, executed by one or more computers or other devices. By way of example, and not limitation, the software product may be stored in a nonvolatile or non-transitory computer-readable storage media that may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

FIG. 1 is an illustration of a trading mechanism configured for dynamic resource pooling in a communications network, in accordance with one embodiment of the present disclosure. As shown, a network manager 130 is configured to manage a pool of communication resources 120 (e.g., bandwidth) that are used by a plurality of users or customers 110 (e.g., customers A-N). For example, the network manager 130 is implemented by a carrier that provides communication resources to the plurality of customers 110. In particular, network manager 130 includes a trading module 133 configured for dynamic trading of bandwidth resources in pool 120 to include determining a reduced rate ratio for customers to sell unused bandwidth back to the carrier. Network manager 130 also includes a resource manager 135 configured to manage the resources in the pool of communication resources 120, such as re-provisioning unused bandwidth back to the pool of communication resources 120, and provisioning and/or allocating bandwidth in the resource pool 120 to customers that need additional bandwidth over their wholesale bandwidth amount.

Moreover, network manager 130 may include a processor 137 and memory 138, wherein the processor 137 is configured to execute computer-executable instructions 139 stored in memory 138. For example, processor 137 is configured for dynamic trading of bandwidth resources in the pool of communication resources 120, and for managing the resources in the pool of communication resources 120, in accordance with embodiments of the present disclosure. In one embodiment, the processor 137 is configured to execute processes outlined in FIG. 2. For instance, the processor 137 may be configured to perform the functions of one or more of the example embodiments described and/or illustrated herein, such as the operations performed by trading module 133 and resource manager 135. The processor 137 may be included within a single or multi-processor computing device or system capable of executing computer-readable instructions. In its most basic form, a computing device may include at least one processor and a system memory. System memory is coupled to processor, and generally represents any type or form of volatile or non-volatile storage device or medium capable of storing data and/or other computer-readable instructions. Examples of system memory include, without limitation, RAM, ROM, flash memory, or any other suitable memory device.

FIG. 2 is a flow diagram illustrating steps in a method for dynamic resource (e.g., bandwidth) provisioning from a resource pool in a communications network, in accordance with one embodiment of the present disclosure. In one embodiment, flow diagram 200 illustrates a computer implemented method for dynamic resource provisioning from a resource pool in a communications network. In another embodiment, flow diagram 200 is implemented within a computer system including a processor configured to perform a method for dynamic resource provisioning from a resource pool in a communications network. In still another embodiment, instructions for performing the method are stored on a non-transitory computer-readable storage medium having computer-executable instructions for causing a computer system to perform a method for dynamic resource (e.g., bandwidth) provisioning from a resource pool in a communications network. The operations of flow diagram 200 are implemented within the network manager 130, including trading module 133, in some embodiments of the present disclosure.

Embodiments of the present disclosure are described within the context of dynamic resource provisioning from a resource pool, and more specifically described using the example of dynamic bandwidth resource provisioning throughout the specification. However, it is understood that embodiments of the present invention are well suited to dynamic provisioning of any type of physical and/or virtual communication resources, such as any parameter defining quality of service (QoS).

The method of flow diagram 200 allows for management of a pool of bandwidth resources available over a communication network. The bandwidth resources are available to a plurality of customers for a predetermined period. The period may be any period (e.g., fractions of a second, minutes, hours, days, etc.) to facilitate dynamic provisioning and trading of resources from a resource pool.

Over the period, the pool of bandwidth resources has a maximum capacity. For example, once the maximum capacity has been allocated to the plurality of customers, no additional resources can be used or allocated to any customer demanding an increase in resources. However, embodiments of the present invention are capable of balancing the overall average needs of all customers with current demands of the customers. In that manner, upon equalization, the system experiences benefits over existing system, including: improved bandwidth utilization that can accommodate an increase of customers; a reduction in overall cost for each customer (e.g., wholesale bandwidth in combination with additionally purchased bandwidth is cheaper); and an increase in revenue for the carrier.

At 210, the method includes receiving a plurality of wholesale bandwidth values from a plurality of computing resources associated with the plurality of customers. That is, customers send in their wholesale bandwidth requests to the carrier, such that bandwidth is guaranteed for the customers over that predetermined period. The bandwidth value denotes the amount of bandwidth requested by a corresponding customer, and wherein the bandwidth is provided at a wholesale price that is negotiated on a customer by customer basis, or is negotiated between the carrier and a group of customers. In addition, the plurality of wholesale bandwidth values is guaranteed over the predetermined period, such that each customer is guaranteed their corresponding amount of bandwidth during the period. In one embodiment, the wholesale bandwidth value is non-value (e.g., zero) for a corresponding customer. Also, the wholesale bandwidth is provided at a guaranteed rate that is negotiated on a customer by customer basis, or negotiated with a group of customers. Further, the total of the wholesale bandwidth request values does not exceed the maximum capacity for bandwidth, in one embodiment.

At 220, the method includes tracking bandwidth resource usage throughout the predetermined period. That is, the carrier is able to manage resources in the pool of communication resources. In that manner, customers that are underutilizing their wholesale amounts of bandwidth have an opportunity to sell their unused bandwidth back to the carrier for inclusion within the resource pool. In addition, this provides the opportunity for customers that require more resources over their wholesale amount of bandwidth to purchase additional resources from the carrier.

For example, the method may include determining unused bandwidth from wholesale bandwidth allocated to a customer in association with the predetermined period. That is, the carrier may be tracking customer usage of bandwidth from the resource pool and may purchase a portion of the unused bandwidth based on current demand on the pool of bandwidth resources from the plurality of customers. In some cases the carrier may not purchase all of the unused bandwidth depending on current demand. In addition, the customer may be tracking its own usage of bandwidth to determine if there is unused bandwidth that can be sold back to the carrier.

The purchase may be initiated by a request from the carrier, and/or may be initiated by the customer who is interested in selling unused bandwidth sending a request to the carrier. As such, when a customer underutilizes its corresponding wholesale bandwidth value or amount this creates unused bandwidth, which may be sold back to the carrier. For example, a reduced rate ratio is determined. In one embodiment, the reduced rate ratio is universally applied to the plurality of customers. The reduced rate ratio is used by a corresponding customer to sell back unused bandwidth from wholesale bandwidth allocated to the customer based on a corresponding wholesale bandwidth value. The bandwidth value determines what the guaranteed rate or wholesale rate for that customer to purchase wholesale bandwidth. For instance, if the wholesale bandwidth value is greater, the guaranteed rate may be discounted from an average rate, whereas if the wholesale bandwidth value is smaller, the guaranteed rate may be higher. That is, a guaranteed rate of selling wholesale bandwidth to the corresponding customer is determined based on the wholesale bandwidth value associated with the customer. The reduced rate ratio is applied to the guaranteed rate to determine a buy back rate of the portion of the unused bandwidth. The portion of unused bandwidth that is sold back to the carrier is added to or reassigned to the pool as available bandwidth.

In particular, available bandwidth is generated by purchasing unused bandwidth from the plurality of customers over the predetermined period. The resource pool contains available bandwidth that can be purchased by any of the plurality of customers to satisfy any increase in demand over their corresponding wholesale bandwidth amounts. In one embodiment, the available bandwidth may start with an initial value, such as when the total of the wholesale bandwidth request values from the customers is less than the maximum capacity provided by the carrier. Additional available bandwidth may be included within the resource pool when one or more customers sell back to the carrier any unused bandwidth.

At 230, at a particular point in time during the predetermined period, the method includes allocating a first portion of available bandwidth from the pool to a first customer based on a reselling rate ratio applicable to the plurality of customers. In one embodiment, the reselling rate ratio is the same for each customer; however, customers may have different guaranteed rates for corresponding wholesale bandwidth.

In particular, one or more customers may purchase bandwidth from the resource pool. For example, a customer may require more than their average wholesale bandwidth value or wholesale amount of bandwidth. As such, that customer may purchase available bandwidth from the resource pool based on the reselling rate ratio. In particular, the method includes determining the reselling rate ratio based on the plurality of wholesale bandwidth values, wherein the reselling rate ratio sets the rate for a corresponding customer to purchase one or more portions of available bandwidth from the pool of bandwidth resources. In addition, the reselling rate ratio is selected to maximize revenue generated from allocating the pool of bandwidth resources.

In one embodiment, the reselling rate ratio is universally applied to the plurality of customers. In that case, the reselling rate ratio is broadcast to the plurality of computing resources associated with the plurality of customers. The reselling rate ratio is applied to the guaranteed rate for a corresponding customer. In that manner, differentiation between customers when purchasing available bandwidth is achieved by negotiating the guaranteed rate on a customer by customer basis, or by negotiating with a group of customers. In one scenario, the method includes receiving from the first customer a request for the first portion of available bandwidth from the pool of resources. The first guaranteed rate of selling wholesale bandwidth to the first customer is determined, wherein the first guaranteed rate is negotiated between the first customer and the carrier. The reselling rate ratio, previously determined, is applied to the first guaranteed rate to determine a sell rate for selling the first portion of available bandwidth to the first customer.

In overview, network virtualization is a promising technology for the next generation network, which is required to offer a more dynamic and flexible network infrastructure. Virtual network embedding plays a vital role in resource allocation of network virtualization. Current virtual network embedding allocates bandwidth in an exclusive manner, that is, the whole bandwidth amount of the virtual network's peak traffic demand is allocated to the virtual network with full availability. However, the exclusive resource allocation may leave the bandwidth under-utilized, leading to high user cost and low carrier revenue. Embodiments of the present invention solves this problem by providing a dynamic bandwidth trading mechanism. In particular, the trading mechanism of embodiments is formulated as a Stackelberg game and a Subgame Perfect Equilibrium is found. The user cost is reduced and the carrier revenue is increased under the disclosed trading mechanism when compared with those under the exclusive resource allocation of previous systems. This is achieved while providing almost full bandwidth availability to the customers.

### Dynamic Bandwidth Trading Mechanism

A dynamic bandwidth trading mechanism utilizing a resource pool is disclosed and formulated as a Stackelberg game. FIG. 3A illustrates a communication network 300A implementing network virtualization built upon resources of a physical network, in accordance with one embodiment of the present disclosure. Above line A-A, one or more virtual networks (VNs) are shown. For example, a virtual system 320 includes VN 322, VN 324, and VN 325 that are assigned to Customer A. Also, virtual system 330 includes VN 332, VN 334, and VN 336 that are assigned to Customer B. Each virtual network is a partition or aggregation of the underlying physical network (PN) of resources (e.g., PN 312, 314, 315, and PN 318). For example, VN 324 is supported by PN 314, and possibly other PNs.

FIG. 3B is a diagram 300B illustrating the use of bandwidth allocated from a resource pool 350 providing communications resources over a predetermined period of time in a network 300A of FIG. 3A, in accordance with one embodiment of the present disclosure. As shown, graph 360 illustrates traffic or bandwidth utilization from resource pool 350 for Customer A, and graph 370 illustrates traffic or bandwidth utilization from resource pool 350 for Customer B.

As shown in FIG. 3B, the utilized traffic for Customer A shown by line 361 in graph 360 and utilized traffic for Customer B shown by line 371 in graph 370 fluctuates over time. In a trading mechanism in an embodiment according to the present invention, a customer purchases a certain amount of bandwidth y at a certain guaranteed rate u (per unit bandwidth and per unit time) at the beginning of the predetermined period. The user can occupy the bandwidth up to y at the guaranteed rate u at any time. The bandwidth y is referred to as the wholesale bandwidth, and the guaranteed rate u is referred to as the wholesale rate. For example, for Customer A, y is illustrated by horizontal line 365.

Using graph 360 corresponding to customer A as a representative example, as time goes on, traffic use may fall below the wholesale bandwidth y, as shown in area 363. The bandwidth below the wholesale bandwidth y and above the current utilization of traffic shown by line 361 in area 363 is unused, and is referred to as unused bandwidth. Customer A has an opportunity to sell the unused bandwidth back to the carrier at a reduced rate αu, 0≦α≦1, wherein the ratio α is defined as the reduced rate ratio. The exact value of α is agreed upon negotiation between the customers and the carrier. The carrier purchases back the unused bandwidth, puts it in the resource pool 350, and sells the bandwidth to other customers in need. In one embodiment, the customer buying available bandwidth and the customer selling the unused bandwidth share the same physical link. Note that the unsold bandwidth of the carrier is also in the resource pool 350.

Still using graph 360 as a representative example, when traffic for Customer A is above the wholesale bandwidth y (e.g., in area 364), Customer A does not have enough bandwidth to accommodate its traffic demand. Under this situation, Customer A has to purchase extra or available bandwidth in the resource pool 350 from the carrier at an increased rate βu, wherein β≧1, in one embodiment. The ratio β is defined as the reselling rate ratio.

There is a chance that the resource pool 350 does not have enough bandwidth to meet all the demand for extra bandwidth, and there might be congestion. The congestion probability is agreed by both the user and the carrier in the service level agreement (SLA).

FIGS. 3A-B show an example of a trading mechanism in an embodiment according to the present invention. In this example, as shown in FIG. 3A, Customer A and Customer B share a common physical link to physical network (PN) 318. At a particular point in time, Customer A may have unused bandwidth illustrated by area 363 of FIG. 3B. At the same point in time, Customer B requires additional bandwidth over its wholesale bandwidth value y, as is shown in area 372. In embodiments of the present invention, the unused bandwidth from Customer A can be purchased by the carrier and placed into resource pool 350 as available bandwidth, and then resold to Customer B to satisfy at least a portion of their increased demand (e.g., in area 372) for bandwidth above their wholesale bandwidth value y.

In the old trading mechanism, the customer purchased the same bandwidth amount as its peak traffic demand and it was not able to sell its unused bandwidth to the carrier for some reimbursement. In the disclosed trading mechanism of embodiments of the present invention, the customer purchases certain amount of wholesale bandwidth at the beginning, and purchases extra bandwidth only when needed. Thus, the customer may spend less over time since it can get reimbursement for the bandwidth it does not use, while the carrier may have higher revenue because it can purchase unused bandwidth from one or more customers at one rate αu, and resell that bandwidth as available bandwidth to other customers at a higher rate βu.

In one embodiment, the dynamic trading mechanism is implemented through a two-stage Stackelberg game. In particular, consider a network virtualization scenario with one carrier and a set of customers. FIG. 4 is a flow diagram 400 illustrating steps in a method for implementing a two-stage Stackelberg game, used to implement dynamic resource pooling in a communications network, in accordance with one embodiment of the present disclosure. In the Stackelberg game, the carrier is the leader, while the customers are the followers. In Stage I, the carrier firstly decides the reselling rate ratio β, which maximizes its revenue, and announces it to the customers. In Stage II, each customer decides the amount of wholesale bandwidth y which minimizes its long-term cost.

In one embodiment, the two-stage Stackelberg game can be analyzed by exploiting the SPE. Backward induction is a general technique for determining SPE. That is, Stage II is performed before proceeding to Stage I. Each of these two stages can be formulated as an independent optimization problem. Next, the SPE is found and illustrates a “win-win” situation. The notations used in the analysis are shown in Table I, below. In the following sections, the disclosed trading mechanism refers to the disclosed dynamic bandwidth trading mechanism, while the old trading mechanism refers to the traditional exclusive bandwidth allocation.

TABLE 1
Notations

| Symbol | Meaning |
|---|---|
| u | Wholesale rate |
| x | User's traffic demand |
| y | Amount of wholesale bandwidth |
| α | Reduced rate ratio |
| β | Reselling rate ratio |
| C | The capacity of a physical link |
| N | The number of users sharing a physical link |
| X | The random variable representing user's traffic |
| λ | The parameter of the user's traffic distribution |
| b | The peak rate of the user's traffic |
| T | The total time period |
| P_{new} | The total cost a user pays to the carrier |
| | using the disclosed trading mechanism |
| P_{old} | The total cost a user pays to the carrier |
| | using the old trading mechanism |
| P_{new}_{_{—}}_{avg} | The average cost a user pays to the carrier |
| | using the disclosed trading mechanism |
| P_{old}_{_{—}}_{avg} | The average cost a user pays to the carrier |
| | using the old trading mechanism |
| R_{new}_{_{—}}_{avg} | The average revenue of the carrier using |
| | the disclosed trading mechanism |
| R_{old}_{_{—}}_{avg} | The average revenue of the carrier using |
| | the old trading mechanism |

In the backward induction of the two-stage Stackelberg game to determine SPE, the first part illustrates how customers determine corresponding wholesale bandwidth amount y to minimize their cost. In the second part, the carrier determines the reselling rate ratio β to maximize its revenue.

Beginning with Stage II to determine wholesale bandwidth amount y, the customer decides the wholesale bandwidth amount y to minimize its cost, given the reselling rate ratio β announced by the carrier in Stage I.

The customer traffic is assumed to follow the truncated exponential distribution with parameters λ and b, as shown in FIG. 5 which is a graph 500 illustrating an example of a probability density function for traffic distribution, in accordance with one embodiment of the present disclosure. In particular, the probability density function (pdf) is disclosed in Eqn. (1), as follows:

$${f}_{x} ( x ) = \frac{λ {e}^{- λ x}}{1 - {e}^{- λ b}} , 0 \leq x \leq b \qquad ( 1 )$$

In Eqn. 1, this assumption of traffic distribution enables the closed-form solution of wholesale bandwidth amount y to be obtained. Note that the disclosed trading mechanism does not depend on any particular traffic distribution. The truncated exponential distribution is used herein for the purposes of simpler analysis.

In addition, the user cost P_{new} under the disclosed trading mechanism over a predetermined time period T can be obtained by the Eqn. (2), as follows:

$${P}_{new} ( β , y ) = y u T - α u T {\int }_{0}^{y} ( y - x ) {f}_{X} ( x ) d x + βu T {\int }_{y}^{b} ( x - y ) {f}_{X} ( x ) d x , \\ 0 \leq y \leq b \qquad ( 2 )$$

In Eqn. 2, the first part is the total payment for the wholesale bandwidth. The second part is the income the customer obtains from the carrier for selling the unused bandwidth. The third part is the total payment for buying extra bandwidth from the carrier.

If the relation in condition (3) illustrated below is assumed,

$$Let {P}_{new \_ avg} ( β , y ) = \frac{{P}_{new} ( β , y )}{u T} , \qquad ( 3 )$$

then the following Eqn. (4) is achieved, as follows:

$${P}_{new \_ avg} ( β , y ) = y - α {\int }_{0}^{y} ( y - x ) {f}_{X} ( x ) d x + β {\int }_{y}^{b} ( x - y ) {f}_{X} ( x ) d x , \\ 0 \leq y \leq b \qquad ( 4 )$$

Then, the following relation in Eqn. (5) is placed into Eqn. (4) to achieve Eqn. (6), below as follows:

$$\begin{matrix} {f}_{X} ( x ) = \frac{{λe}^{- λ x} }{1 - {e}^{- λ b}} & ( 5 ) \\ {P}_{new \_ avg} ( β , y ) = y - \frac{1}{1 - {e}^{- λ b}} [ ( α - {βe}^{- λ b} ) y + ( \frac{α}{λ} - \frac{β}{λ} ) {e}^{- λ y} - \frac{α}{λ} + β ( \frac{1}{λ} + b ) {e}^{- λ b} ] , \\ 0 \leq y \leq b & ( 6 )\end{matrix}$$

FIG. 6 is a graph 600 illustrating an example of average user cost versus wholesale bandwidth amount, in accordance with one embodiment of the present disclosure. In particular, graph 600 shows the average user cost under different wholesale bandwidth amount y and different peak traffic demand b, where α=0.05, α=0.5, and β=1.5. Graph 600 shows that a minimum cost exists under a unique value of y. The unique y that minimizes the user cost is denoted as y* in Eqn. (7), below:

y*(β)=argmin_{0≦y≦b}P_{new}_{_{—}}_{avg}(β,y) (7)

If the wholesale bandwidth amount is less than y*, the customer may have to pay more for the extra bandwidth. On the other hand, if the wholesale bandwidth amount is more than y*, the customer pays less for the extra bandwidth, but there will be more unused bandwidth and the penalty is larger. In order to find out y*(β), take the partial differential equation of Eqn. (6) over y to obtain Eqn. (8), below:

$$\frac{\partial {P}_{new \_ avg} ( β , y )}{\partial y} = 1 - \frac{α - β {e}^{- λ b}}{1 - {e}^{- λ b}} - \frac{( β - α ) {e}^{- λ y}}{1 - {e}^{- λ b}} \qquad ( 8 )$$

Under the condition of Eqn. (9).

$$Let \text{:} \frac{\partial {P}_{new \_ avg} ( β , y )}{\partial y} = 0 , \qquad ( 9 )$$

Then the result of Eqn. (10) is realized below:

$${y}^{*} ( β ) = - \frac{1}{λ} ln \frac{( β - 1 ) {e}^{- λ b} - α + 1}{β - α} \qquad ( 10 )$$

As such, from 0≦y*(β)≦b: β≧1 and α≦1, given that λ>0 and b≧0. Thus, as long as β≧1 and α≦1 hold, the unique y*(β) is found that minimizes the user cost. FIG. 7 is a graph 700 illustrating an example of wholesale bandwidth amount that minimizes user cost versus reselling ratio, in accordance with one embodiment of the present disclosure. In particular, FIG. 8 shows y* under different β and different b, where λ=0.05, α=0.5. It shows that y* increases when β increases. When β increases, the extra bandwidth becomes more expensive, thus the customer prefers to buy more wholesale bandwidth in order to reduce the need for extra bandwidth. In one scenario, when β is 1.0, the customer does not buy any wholesale bandwidth because the wholesale rate and the extra bandwidth rate are the same, and thus there is no need to purchase long-term wholesale bandwidth.

Finally, the minimum average user cost under the disclosed trading mechanism is only determined by β and can be expressed as Eqn. (11), below:

$${P}_{new \_ avg}^{*} ( β ) = {y}^{*} ( β ) - \frac{1}{1 - {e}^{- λ b}} [ ( α - β {e}^{- λ b} ) {y}^{*} ( β ) + ( \frac{α}{λ} - \frac{β}{λ} ) {{e}^{- λ y}}^{*} ( β ) - \frac{α}{λ} + β ( \frac{1}{λ} + b ) {e}^{- λ b} ] \qquad ( 11 )$$

In the old trading mechanism, the customer purchases wholesale bandwidth at its peak traffic demand, which is b in this case. Thus, the cost to the customer using the old trading mechanism is expressed in Eqn. (12), below:

P_{old}=buT (12)

Similar to the analysis to obtain the P_{new}_{_{—}}_{avg}, let the condition in Eqn. (13) be true, which results in Eqn. (14), as follows:

$$\begin{matrix}Let {P}_{old \_ avg} = \frac{{P}_{old}}{u T} , then \text{:} & ( 13 ) \\ {P}_{old \_ avg} = b & ( 14 )\end{matrix}$$

FIG. 8 is a graph 800 illustrating an example of average customer cost versus reselling ratio in accordance with one embodiment of the present disclosure. In graph 600, the average customer cost is illustrated under different β and different b, where λ=0.05, α=0.5. It can be seen that under the disclosed trading mechanism, the customer cost increases along with the increase of β. Although the customer can increase the amount of wholesale bandwidth to make up for the rising price of extra bandwidth, it is not enough to compensate for the increasing payment for extra bandwidth. This is why the new average customer cost increases non-linearly. The old average customer cost is constant since it is not affected by the β values. As shown, customers pay less under the disclosed trading mechanism of embodiments of the present invention. The cost savings are up to 54.2% when b=10, and 62.1% when b=30.

The β value is decided by the carrier in Stage I, which is shown below. Under the new β value, the P_{new}_{_{—}}_{avg}(β)<P_{old}_{_{—}}_{avg} still holds. In particular, the carrier determines the reselling rate ratio β to maximize its total revenue in Stage I. For simpler analysis, all the customers follow the same truncated exponential distribution with the same parameters λ and b. Also, the traffic distribution of different customers are independent. Assuming the traffic demands of Customer 1, Customer 2, . . . , Customer n are represented as random variables X₁, X₂, . . . , Xₙ, then the sequence of variables {X₁, X₂, . . . , Xₙ} is i.i.d.

The carrier solves the following problem illustrated in Eqn. (15), as follows:

$$\begin{matrix}{β}^{*} = arg {max}_{β \geq 1} {R}_{new \_ avg} ( β ) \\ = arg {max}_{β \geq 1} {N}_{new} ( β ) {P}_{new \_ avg}^{*} ( β )\end{matrix} \qquad ( 15 )$$

In Eqn. (15), the N_{new}(β) is the number of customers the carrier can accommodate under β using the disclosed trading mechanism. When β is small, the carrier earns less from reselling the unused bandwidth. On the other hand, when β is large, the carrier earns more from reselling the unused bandwidth; however, the number of users it can accommodate is smaller. The reason is that y*(β) is larger when β is larger and the carrier has to guarantee each user's wholesale bandwidth amount y*(β) under given capacity C, i.e., N_{new}(β)y*(β)≦C, and thus N_{new}(β) becomes smaller when β increases. From the analysis above, there should be a β* which maximizes the carrier revenue.

Note that N_{new}≠N_{old}. In the old trading mechanism, the customer buys the same bandwidth amount as its peak traffic demand and it does not sell out the unused bandwidth. Thus, N_{old} is obtained by Eqn. (16), as follows:

$${N}_{old} = ⌊ \frac{C}{b} ⌋ \qquad ( 16 )$$

On the other hand, in the disclosed trading mechanism of embodiments of the present invention, the carrier buys the unused bandwidth from one customer and sells it to other customers in need. Thus, the disclosed trading mechanism of embodiments may support more customers than the old trading mechanism. However, the multiplexing of customers in the disclosed trading mechanism may result in congestion, while there is limited or no congestion in the old trading mechanism. In order to make the disclosed trading mechanism and old trading mechanism comparable, the congestion probability is limited to a very small value, such that it is negligible in this analysis. To measure the congestion probability, the aggregated traffic of all the customers and its distribution are studied below.

Suppose the aggregated traffic of n users is denoted by a random variable Sₙ, i.e., Sₙ=X₁+X₂+ . . . +Xₙ. According to the classical central limit theorem, given that {X₁, X₂, . . . , Xₙ} is a sequence of i.i.d random variables with E[Xᵢ]=μ and Var[Xᵢ]=σ₂<∞, then as n is approaching infinity, the random variable Sₙ converges to a normal distribution N(nμ, nσ²). In this analysis, the random variable Xᵢ follows a truncated exponential distribution with parameters λ and b, and its mean is given by Eqn. (17):

$$μ = \frac{1}{λ} - \frac{b {e}^{- λ b}}{1 - {e}^{- λ b}} \qquad ( 17 )$$

The variance is expressed in Eqn. (18) as follows:

$${σ}^{2} = \frac{1}{{e}^{- λ b} - 1} [ {b}^{2} {e}^{- λ b} + \frac{2}{λ} ( b {e}^{- λ b} + \frac{1}{λ} {e}^{- λ b} - \frac{1}{λ} ) ] - {μ}^{2} \qquad ( 18 )$$

Assume there is a large number of users, Sₙ then the normal distribution N(nμ, nσ₂) approximately follows. According to one rule, approximately 99.7% of the values of Sₙ lie within 3 standard deviations of the mean, i.e., Prob(nμ−3\sqrt{n}σ≦sₙ≦nμ+3\sqrt{n}σ)≈0.9973. Then Prob(sₙ≦nμ+3\sqrt{n}σ)≈0.999. Thus, if nμ+3\sqrt{n}σ≦C, then the congestion probability is at most 0.1%, which is negligible. Meanwhile, the carrier has to guarantee each customer's wholesale bandwidth amount y*(β) at any time, i.e., ny*(β)≦C. Together, there are two constraints for N_{new}(β), as illustrated in Eqns. (19-20), resulting in Eqn. (21), below:

$$\begin{matrix} {N}_{new} ( β ) \leq ⌊ {( \frac{- 3 σ + \sqrt{9 {σ}^{2} + 4 μ C}}{2 μ} )}^{2} ⌋ & ( 19 ) \\ {N}_{new} ( β ) \leq ⌊ \frac{C}{{y}^{*} ( β )} ⌋ & ( 20 ) \\ Overall , {N}_{new} ( β ) = min ( ⌊ {( \frac{- 3 σ + \sqrt{9 {σ}^{2} + 4 μ C}}{2 μ} )}^{2} ⌋ , ⌊ \frac{C}{{y}^{*} ( β )} ⌋ ) & ( 21 )\end{matrix}$$

FIG. 9 is a graph 900 illustrating an example of average number of users versus reselling ratio, in accordance with one embodiment of the present disclosure. In particular, FIG. 9 shows the number of customers under different β and different b, where λ=0.05, α=0.5, and C=10⁴. From FIG. 9, it can be seen that under the disclosed trading mechanism of embodiments of the present invention, the number of customers is constant when β is small, and starts to decrease after a certain inflection point. When β is small, y* is small, and thus N_{new}(β) obtained by Eqn. (20) is large. Under this situation, Eqn. (19) is dominant over Eqn. (20). Since Eqn. (19) does not depend on β, the N_{new} remains unchanged. However, when β increases to a certain value. N_{new}(β) obtained by Eqn. (20) is smaller than that obtained by Eqn. (19), and thus Eqn. (20) dominates. This is why N_{new} starts to decrease when β is greater than a certain value. As shown in FIG. 9, the disclosed trading mechanism supports more users than the old trading mechanism. The increase in the number of users is up to 109.5% when b=10, and 145.0% when b=30.

Finally, the maximum carrier revenue under the disclosed trading mechanism can be given by Eqn. (22), below:

R*_{new}_{_{—}}_{avg}=N_{new}(β*)P*_{new}_{_{—}}_{avg}(β*); (22)

and the maximum carrier revenue under the old trading mechanism is expressed in Eqn. (23), below:

$${R}_{old \_ avg} = {N}_{old} {P}_{old \_ avg} = ⌊ \frac{C}{b} ⌋ b \qquad ( 23 )$$

FIG. 10 is a graph 1000 illustrating an example of carrier revenue versus reselling ratio, in accordance with one embodiment of the present disclosure. As shown, FIG. 10 shows the carrier revenue under different β and b, where λ=0.05, α=0.5, and C=10⁴. It is shown that under the disclosed trading mechanism, the carrier revenue increases before a certain value of β, and decreases after that. As discussed in FIG. 9, the number of customers is constant before the inflection point, and thus the revenue increase comes from the rising price of extra bandwidth. When β increases to the inflection point, the number of customers starts to drop due to the increase of y*. Although the price of the extra bandwidth continues to increase, it is not sufficient to make up for the reducing number of customers. On the other hand, the carrier revenue under the old trading mechanism remains constant since it does not depend on β. Also, the R_{old}_{_{—}}_{avg} under b=10 and b=30 are almost the same, since R_{old}_{_{—}}_{avg}≈C. From FIG. 8 and FIG. 10 together, when b=10, β*=1.58, R*_{new}_{_{—}}_{avg}=12406.6, R_{old}_{_{—}}_{avg}=10000, P*_{new}_{_{—}}_{avg}=5.9, P_{old}_{_{—}}_{avg}=10. Using the disclosed trading mechanism of embodiments of the present invention, the carrier revenue is increased by 24.1%, and the customer cost is decreased by 41.0%. When b=30, β*=1.72, R*_{new}_{_{—}}_{avg}=12723.8, R_{old}_{_{—}}_{avg}=9990, P*_{new}_{_{—}}_{avg}=15.6, P_{old}_{_{—}}_{avg}=30. Using the disclosed trading mechanism, the carrier revenue is increased by 27.4%, and the customer cost is decreased by 48.0%. Consequently, in this case, the “win-win” situation exists under SPE.

Thus, according to embodiments of the present disclosure, a dynamic bandwidth trading mechanism for the users and carrier to exchange the unused bandwidth is disclosed herein. For instance, systems and methods are described for dynamic resource (e.g., bandwidth) provisioning from a resource pool in a communications network, in accordance with embodiments of the present disclosure. In particular, the trading mechanism disclosed in embodiments of the present invention is formulated as a Stackelberg game. The Subgame Perfect Equilibrium (SPE) is found through backward induction. This results in reduced customer cost and an increase in carrier revenue under equilibrium, while keeping a 99.9% bandwidth availability to the users.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

Although the present invention and its advantages have been described in detail, it should be understood that various changes, substitutions, and alterations can be made herein without departing from the spirit and scope of the invention as defined by the appended claims. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Embodiments according to the present disclosure are thus described. While the present disclosure has been described in particular embodiments, it should be appreciated that the disclosure should not be construed as limited by such embodiments, but rather construed according to the below claims.

What is claimed:

1. A computer system for managing a pool of bandwidth resources available over a communication network, comprising:
a processor configured to:
receive a plurality of wholesale bandwidth values requesting bandwidth from said pool of bandwidth resources from a plurality of computing resources associated with a plurality of customers, wherein said plurality of wholesale bandwidth values is guaranteed over a predetermined period, and wherein said pool has a maximum capacity;
track bandwidth resource usage throughout said predetermined period; and
at a particular point in time during said predetermined period, allocate a first portion of available bandwidth from said pool to a first customer based on a reselling rate ratio applicable to said plurality of customers, wherein said available bandwidth is generated by purchasing unused bandwidth from said plurality of customers over said predetermined period.

2. The computer system of claim 1, wherein said processor is further configured to:
determine said reselling rate ratio based on said plurality of wholesale bandwidth values, wherein said reselling rate ratio sets the rate for a corresponding customer to purchase one or more portions of said available bandwidth from said pool of bandwidth resources, wherein said reselling rate ratio is selected to maximize revenue generated from allocating said pool of bandwidth resources; and
broadcast said reselling rate ratio to said plurality of computing resources.

3. The computer system of claim 2, wherein when said processor is configured to allocate said first portion of available bandwidth, said processor is further configured to:
receive from said first customer a request for said first portion of available bandwidth from said pool;
determine a first guaranteed rate of selling wholesale bandwidth to said first customer based on a first wholesale bandwidth value associated with said first customer; and
apply said reselling rate ratio to said first guaranteed rate to determine a sell rate for said first portion of available bandwidth.

4. The computer system of claim 1, wherein said processor is further configured to:
set a reduced rate ratio for a corresponding customer to sell back unused bandwidth from wholesale bandwidth allocated to said corresponding customer based on a corresponding wholesale bandwidth value.

5. The computer system of claim 4, wherein said processor is further configured to:
determine a first unused bandwidth from wholesale bandwidth allocated to a second customer in association with said predetermined period when tracking bandwidth resource usage;
purchase a portion of said first unused bandwidth based on current demand on said pool of bandwidth resources from said plurality of customers, and wherein said portion of said first unused bandwidth is purchased based on said reduced rate ratio applicable to said plurality of customers; and
reassign said portion of said first unused bandwidth to said pool as available bandwidth.

6. The computer system of claim 4, wherein said processor is further configured to:
receive a request to sell a portion of a first unused bandwidth of wholesale bandwidth allocated to a second customer;
determine a first guaranteed rate of selling wholesale bandwidth to said second customer based on a wholesale bandwidth value associated with said second customer; and
apply said reduced rate ratio to said first guaranteed rate to determine a buy back rate for said portion of said first unused bandwidth.

7. The computer system of claim 1, wherein a wholesale bandwidth value for a corresponding customer is a non-value.

8. The method of claim 1, wherein said plurality of wholesale bandwidth values does not exceed said maximum capacity.

9. The method of claim 1, wherein when said processor is configured to allocate a first portion of available bandwidth from said pool to a first customer, said processor is further configured to:
allocate said first portion from unused bandwidth of a second customer, wherein said first and second customers share a common physical resource providing said available bandwidth.

10. A method for managing a pool of bandwidth resources available over a communication network executed by a processor, comprising:
receiving a plurality of wholesale bandwidth values requesting bandwidth from said pool of bandwidth resources from a plurality of computing resources associated with said plurality of customers, wherein said plurality of wholesale bandwidth values is guaranteed over a predetermined period, and wherein said pool has a maximum capacity;
tracking bandwidth resource usage throughout said predetermined period; and
at a particular point in time during said predetermined period, allocating a first portion of available bandwidth from said pool to a first customer based on a reselling rate ratio applicable to said plurality of customers, wherein said available bandwidth is generated by purchasing unused bandwidth from said plurality of customers over said predetermined period.

11. The method of claim 10, further comprising:
determining said reselling rate ratio based on said plurality of wholesale bandwidth values, wherein said reselling rate ratio sets the rate for a corresponding customer to purchase one or more portions of said available bandwidth from said pool of bandwidth resources, wherein said reselling rate ratio is selected to maximize revenue generated from allocating said pool of bandwidth resources; and
broadcasting said reselling rate ratio to said plurality of computing resources

12. The method of claim 11, wherein said allocating a first portion of available bandwidth further comprises:
receiving from said first customer a request for said first portion of available bandwidth from said pool;
determining a first guaranteed rate of selling wholesale bandwidth to said first customer based on a first wholesale bandwidth value associated with said first customer; and
applying said reselling rate ratio to said first guaranteed rate to determine a sell rate for said first portion of available bandwidth.

13. The method of claim 10, further comprising:
setting a reduced rate ratio for a corresponding customer to sell back unused bandwidth from wholesale bandwidth allocated to said corresponding customer based on a corresponding wholesale bandwidth value.

14. The method of claim 13, further comprising:
wherein said tracking bandwidth resource usage comprises determining a first unused bandwidth from wholesale bandwidth allocated to a second customer in association with said predetermined period;
purchasing a portion of said first unused bandwidth based on current demand on said pool of bandwidth resources from said plurality of customers, and wherein said portion of said first unused bandwidth is purchased based on said reduced rate ratio applicable to said plurality of customers; and
reassigning said portion of said first unused bandwidth to said pool as available bandwidth.

15. The method of claim 13, further comprising:
receiving a request to sell a portion of a first unused bandwidth or wholesale bandwidth allocated to a second customer;
determining a first guaranteed rate of selling wholesale bandwidth to said second customer based on a wholesale bandwidth value associated with said second customer; and
applying said reduced rate ratio to said first guaranteed rate to determine a buy back rate for said portion of said first unused bandwidth.

16. The method of claim 10, wherein a wholesale bandwidth value for a corresponding customer is a non-value.

17. The method of claim 10, wherein said plurality of wholesale bandwidth values does not exceed said maximum capacity.

18. A non-transitory computer-readable medium having computer-executable instructions for causing a computer system to perform a method for managing a pool of bandwidth resources available over a communication network, comprising:
receiving a plurality of wholesale bandwidth values requesting bandwidth from said pool of bandwidth resources from a plurality of computing resources associated with said plurality of customers, wherein said plurality of wholesale bandwidth values is guaranteed over said predetermined period, wherein said pool has a maximum capacity;
tracking bandwidth resource usage throughout said predetermined period; and
at a particular point in time during said predetermined period, allocating a first portion of available bandwidth from said pool to a first customer based on a reselling rate ratio applicable to said plurality of customers, wherein said available bandwidth is generated by purchasing unused bandwidth from said plurality of customers over said predetermined period.

19. The computer-readable medium of claim 18, wherein said method further comprises:
determining said reselling rate ratio based on said plurality of wholesale bandwidth values, wherein said reselling rate ratio sets the rate for a corresponding customer to purchase one or more portions of said available bandwidth from said pool of bandwidth resources, wherein said reselling rate ratio is selected to maximize revenue generated from allocating said pool of bandwidth resources; and
broadcasting said reselling rate ratio to said plurality of computing resources.

20. The computer-readable method of claim 19, wherein said allocating a first portion of available bandwidth in said method further comprises:
receiving from said first customer a request for said first portion of available bandwidth from said pool;
determining a first guaranteed rate of selling wholesale bandwidth to said first customer based on a first wholesale bandwidth value associated with said first customer; and
applying said reselling rate ratio to said first guaranteed rate to determine a sell rate for said first portion of available bandwidth.
